(19) United States
(12) Patent Application Publication
(10) Pub. No.: US 2020/0220192 A1
(43) Pub. Date: Jul. 9, 2020

(54) PROTON CONDUCTOR AND FUEL CELL

(71) Applicants: DENSO CORPORATION, Kariya-city (JP); Kyoto University, Kyoto-shi (JP); TOKYO INSTITUTE OF TECHNOLOGY, Tokyo (JP)

(72) Inventors: Kazuki TAKAHASHI, Kariya-city (JP); Tomoya ITAKURA, Kariya-city (JP); Kenichiro KAMI, Kariya-city (JP); Satoshi HORIKE, Kyoto-city (JP); Susumu KITAGAWA, Kyoto-city (JP); Tomofumi TADA, Tokyo (JP)

(21) Appl. No.: 16/728,016

(22) Filed: Dec. 27, 2019

(30) Foreign Application Priority Data
Jan. 8, 2019 (JP) 2019-001062

(51) Int. Cl. H01M 8/1016

(52) U.S. Cl. CPC H01M 8/1016; H01M 2300/0065; H01M 2300/0091

(57) ABSTRACT

A proton conductor includes an anionic molecule and a cationic organic molecule. The anionic molecule is an anionic metal complex molecule. For example, the anionic metal complex molecule includes at least one chemical bond between a metal ion and an oxoacid ion. For example, the proton conductor can be used as an electrolyte membrane included in a fuel cell.

### CROSS REFERENCE TO RELATED APPLICATION

The present application claims the benefit of priority from Japanese Patent Application No. 2019-1062 filed on Jan. 8, 2019. The entire disclosure of the above application is incorporated herein by reference.

### TECHNICAL FIELD

The present disclosure relates to a proton conductor and a fuel cell.

### BACKGROUND

At present, from the viewpoint of cost reduction and system simplification of a solid polymer fuel cell system, a fuel cell that operates at an operating temperature of 100° C. or more and under a condition of no humidification is desired. In order to operate the fuel cell without humidification, a proton conductor plays an important role. Since phosphoric acid is a promising proton carrier, it is believed that phosphoric acid-containing structures containing phosphoric acid are suitable as the proton conductors.

### SUMMARY

The present disclosure provides a proton conductor that includes an anionic molecule and a cationic organic molecule, and the anionic molecule is an anionic metal complex molecule. For example, the proton conductor can be used as an electrolyte membrane included in a fuel cell.

### BRIEF DESCRIPTION OF DRAWINGS

The features and advantages of the present disclosure will become apparent from the following detailed description made with reference to the accompanying drawings. In the drawings:

FIG. 1 is a diagram schematically showing a fuel cell according to an embodiment of the present disclosure;

FIG. 2 is a diagram showing an example of a proton conductor according to the present embodiment;

FIG. 3 is a graph showing a result of analyzing a proton conductor according to Example 1 by mass spectrometry;

FIG. 4 is a graph showing a result of analyzing the proton conductor according to Example 1 by mass spectrometry;

FIG. 5 is a graph showing a result of analyzing a proton conductor according to Example 2 by mass spectrometry;

FIG. 6 is a graph showing a result of analyzing the proton conductor according to Example 2 by mass spectrometry;

FIG. 7 is a graph showing results of analyzing the proton conductors according to Examples 1 and 2 by X-ray scattering;

FIG. 8 is a graph showing results of analyzing the proton conductors according to Examples 1 and 2 by X-ray absorption fine structure analysis;

FIG. 9 is a graph showing relationships between ionic conductivities and temperatures of proton conductors according to respective examples; and

FIG. 10 is a graph showing temporal changes in ionic conductivity of proton conductors according to respective examples and a comparative example.

### DETAILED DESCRIPTION

As an example, a phosphoric acid-containing structure may be formed by chemical bonding of phosphoric acid with other components (for example, phosphosilicate glass, phosphate glass, or metal phosphates). However, such phosphoric acid-containing structure has low water resistance and low proton conductivity. As another example, a phosphoric acid-containing structure may be formed by introducing phosphoric acid into a chemically stable matrix material. Such a matrix material has pores causing capillarity, and can be suitably used as a material for the proton conductor.

However, in the phosphoric acid-containing structure formed by doping the matrix material with phosphoric acid, since an interaction between the pores and phosphoric acid is week, phosphoric acid easily flows out. The flowing-out phosphoric acid is deteriorated by condensation in a high temperature environment. Since the proton conductivity is lowered by the outflow of phosphoric acid from the proton conductor, a largely excessive amount of phosphoric acid is required to realize high proton conductivity.

A proton conductor according to an aspect of the present disclosure includes an anionic molecule and a cationic organic molecule, and the anionic molecule is an anionic metal complex molecule.

In the anionic metal complex molecule, a metal ion and a ligand having proton conductivity are strongly bonded, and the ligand can be restricted from separating and flowing out from the proton conductor. Accordingly, a stability of a structure of the proton conductor can be improved, and a decrease in proton conductivity can be suppressed.

In addition, when multiple ligands are coordinated to the metal ion, multiple proton conduction paths are formed per structure, and a proton conduction performance can be improved.

In addition, since the cationic organic molecule and the anionic molecule are weakly bonded to each other with charges having opposite signs, the structure can be a gelled substance. The gelled structure can increase a proton mobility, and can further increase the proton conductivity.

Hereinafter, an embodiment of the present disclosure will be described with reference to the drawings.

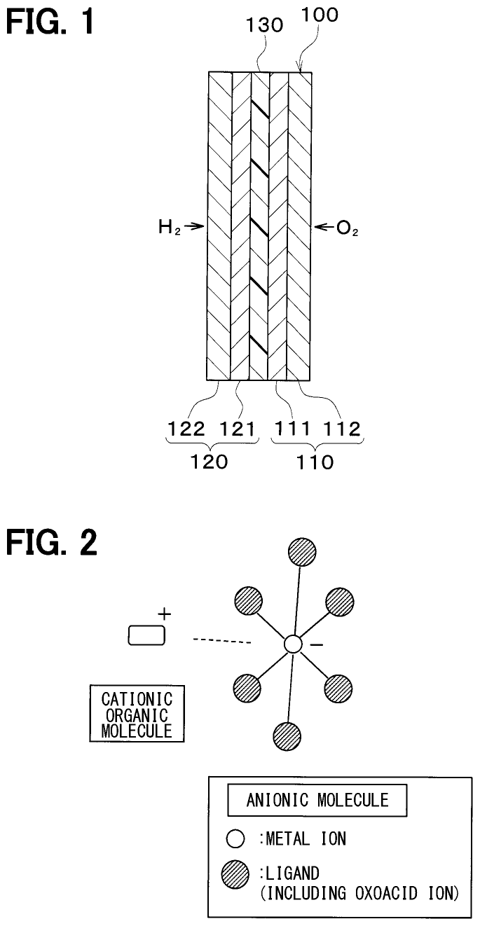

As shown in FIG. 1, a fuel cell 100 includes a cathode electrode 110, an anode electrode 120, and an electrolyte membrane 130. The cathode electrode 110 is also referred to as an air electrode, and the anode electrode 120 is also referred to as a hydrogen electrode.

The fuel cell 100 outputs an electric energy using an electrochemical reaction between a fuel gas (hydrogen) and an oxidant gas (oxygen in air). The fuel cell 100 is provided as a basic unit, and multiple fuel cells 100 can be stacked as a stack structure to be used.

When the fuel cell 100 is supplied with a reaction gas such as hydrogen and air, hydrogen and oxygen electrochemically react with each other to output electric energy as described below.

H₂→2H⁺+2e⁻ (Anode Side)

2H⁺+½O₂+2e⁻→H₂O (Cathode Side)

In this case, in the anode electrode 120, hydrogen is ionized into electron (e⁻) and proton (H⁺) by the catalytic reaction, and the proton (H⁺) moves through the electrolyte membrane 130. On the other hand, in the cathode electrode 110, the protons (H⁺) moving from the anode electrode 120, electrons flowing from the outside, and oxygen (O₂) in the air react to generate water.

The cathode electrode 110 is made of a cathode catalyst layer 111 and a cathode diffusion layer 112. The cathode catalyst layer 111 is disposed in close contact with a surface of the electrolyte membrane 130, the surface being adjacent to the air electrode. The cathode diffusion layer 112 is arranged on an outer side of the cathode catalyst layer 111.

The anode electrode 120 is made of an anode catalyst layer 121 and an anode diffusion layer 122. The anode catalyst layer 121 is disposed in close contact with a surface of the electrolyte membrane 130, the surface being adjacent to the hydrogen electrode. The anode diffusion layer 122 is disposed on an outer side of the anode catalyst layer 121.

Each of the catalyst layers 111 and 121 is formed of, for example, a carbon-supported platinum catalyst in which a catalyst such as platinum for promoting an electrochemical reaction is supported on a carbon support, and each of the diffusion layers 112 and 122 is formed of, for example, a carbon cloth.

The electrolyte membrane 130 is a proton conductor. As shown in FIG. 2, the proton conductor includes an anionic molecule and a cationic organic molecule. The anionic molecule has a negative charge, and the cationic organic molecule has a positive charge.

Between the anionic molecule and the cationic organic molecule, which have charges of opposite signs, an attractive force acts. That is, the anionic molecule and the cationic organic molecule form a single structure as a whole by balancing the charges.

As the anionic molecule, an anionic metal complex molecule can be used. The anionic metal complex molecule includes a metal ion and a ligand that functions as a proton carrier. As the ligand, an oxoacid ion can be used.

The anionic metal complex molecule includes at least one chemical bond between the metal ion and the oxoacid ion. The oxoacid ion is a ligand having proton conductivity. It is required that at least one oxoacid ion is chemically bonded to the metal ion, and it is preferable that multiple oxoacid ions are chemically bonded. A ligand other than the oxoacid ion such as a water molecule may also be bonded to the metal ion.

The chemical bond between the metal ion and the oxoacid ion can be exemplified by a coordination bond and a covalent bond, but is not limited thereto. The anionic molecule is only required to have the negative charge as a whole by the metal ion and the oxoacid ion, and preferably has a charge of −1.

As the metal ion of the anionic metal complex molecule, it is preferable to use a metal whose valence does not change, and it is preferable to use a metal having no d electrons. As a metal constituting the metal ion of the anionic metal complex molecule, at least one metal selected from the group consisting of Al, Ga, Cs, Ba, K, Ca, Na, Mg, Zr, Ti, La, and Pr can be used.

When the number of metal coordination increases, the number of oxoacid ions to be chemically bonded can be increased, and the proton conductivity can be improved. FIG. 2 shows an example of the structure of a proton conductor including a metal ion having a coordination number of 6, and six ligands including an oxoacid ion are chemically bonded to the metal ion.

The oxoacid ion in the anionic metal complex molecule may be any one having proton conductivity. As an oxoacid constituting the oxoacid ion in the anionic metal complex molecule, at least one selected from the group consisting of phosphoric acid, sulfuric acid, nitric acid and boric acid can be used.

As the cationic organic molecule, it is preferable to use an organic molecule having a charge of +1. As the cationic organic molecule, at least one selected from the group consisting of ammonium cation, imidazolium cation, pyridinium cation, pyrrolidinium cation, and phosphonium cation can be used.

The bond between the anionic molecule and the cationic organic molecule is weaker than the chemical bond between the metal ion and the oxoacid ion. The structure including the anionic molecule and the cationic organic molecule has a uniform composition, and does not form a polymer.

As shown in FIG. 2, in the structure according to the present embodiment, the multiple oxoacid ions are chemically bonded to the metal ion. Thus, multiple conduction paths are formed per structure, and the proton conduction performance is improved. In addition, since the metal ion and the oxoacid ions are strongly bonded by chemical bonds, the outflow of oxoacid ions can be restricted. In addition, since the cationic organic molecule and the anionic molecule are weakly bonded to each other with charges having opposite signs, the structure can be a gelled substance. The gelled structure can increase a proton mobility, and can further increase the proton conductivity.

The proton conductor according to the present embodiment will be described using examples and a comparative example.

In Examples 1 and 2, an ammonium cation was used as the cationic organic molecule, Al was used as the metal ion of the anionic molecule, and phosphoric acid was used as the anionic molecular oxoacid ion. Examples 3 and 4 differ from Examples 1 and 2 in that an imidazolium cation is used as the cationic organic molecule. Examples 5 and 6 differ from Examples 1 and 2 in that Ba is used as the metal ion of the anionic molecule. Examples 7 and 8 differ from Examples 1 and 2 in that La is used as the metal ion of the anionic molecule. The coordination number of Al and Ba is 6, and the coordination number of La is 6 or 12.

### Example 1

As raw materials of a proton conductor, aluminum dihydrogen phosphate (Al(H₂PO₄)₃) and diethylmethylammonium dihydrogenphosphate ([dema] [H₂PO₄]) were used at a molar ratio of 1:1. The above-described raw materials and water as a solvent were mixed in an eggplant flask and were stirred at room temperature for 12 hours. Then, water was removed by an evaporator to obtain a gelled proton conductor according to Example 1. In the proton conductor according to Example 1, four H₂PO₄⁻ and two H₂O are chemically bonded to Al³⁺.

### Example 2

The proton conductor according to Example 1 was vacuum dried at 120° C. Then, orthophosphoric acid (H₃PO₄) was added in amount of 2 equivalents with respect to Al, and was mixed in a mortar for 10 minutes under an Ar atmosphere. Accordingly, a gelled proton conductor according to Example 2 was obtained. In the proton conductor according to Example 2, two H₂O in the proton conductor according to Example 1 are substituted with H₃PO₄, and four H₂PO₄ and two H₃PO₄ are chemically bonded to Al³⁺.

### Example 3

As raw materials of a proton conductor, aluminum dihydrogen phosphate and ethylmethylimidazolium dihydrogenphosphate were used at a molar ratio of 1:1. The above-described raw materials and water as a solvent were mixed in an eggplant flask and were stirred at room temperature for 12 hours. Then, water was removed by an evaporator to obtain a gelled proton conductor according to Example 3. In the proton conductor according to Example 3, four H₂PO₄⁻ and two H₂O are chemically bonded to Al³⁺.

### Example 4

The proton conductor according to Example 3 was vacuum dried at 120° C. Then, orthophosphoric acid was added in amount of 2 equivalents with respect to Al, and was mixed in a mortar for 10 minutes under an Ar atmosphere. Accordingly, a gelled proton conductor according to Example 4 was obtained. In the proton conductor according to Example 4, two H₂O in the proton conductor according to Example 3 are substituted with H₃PO₄, and four H₂PO₄⁻ and two H₃PO₄ are chemically bonded to Al³⁺.

### Example 5

As raw materials of a proton conductor, barium dihydrogen phosphate (Ba(H₂PO₄)₂) and diethylmethylammonium dihydrogenphosphate were used at a molar ratio of 1:1. The above-described raw materials and water as a solvent were mixed in an eggplant flask and were stirred at room temperature for 12 hours. Then, water was removed by an evaporator to obtain a gelled proton conductor according to Example 5. In the proton conductor according to Example 5, three H₂PO₄⁻ and three H₂O are chemically bonded to Ba²⁺.

### Example 6

The proton conductor according to Example 5 was vacuum dried at 120° C. Then, orthophosphoric acid was added in amount of 3 equivalents with respect to Ba, and was mixed in a mortar for 10 minutes under an Ar atmosphere. Accordingly, a gelled proton conductor according to Example 6 was obtained. In the proton conductor according to Example 6, three H₂O in the proton conductor according to Example 5 are substituted with H₃PO₄, and three H₂PO₄⁻ and three H₃PO₄ are chemically bonded to Ba²⁺.

### Example 7

As raw materials of a proton conductor, lanthanum dihydrogen phosphate (La(H₂PO₄)₃) and diethylmethylammonium dihydrogenphosphate were used at a molar ratio of 1:1. The above-described raw materials and water as a solvent were mixed in an eggplant flask and were stirred at room temperature for 12 hours. Then, water was removed by an evaporator to obtain a gelled proton conductor according to Example 7. In the proton conductor according to Example 7, in a case where the coordination number of La is 6, four H₂PO₄⁻ and two H₂O are chemically bonded to La³⁺, and in a case where the coordination number of La is 12, four H₂PO₄⁻ and eight H₂O are chemically bonded to La³⁺.

### Example 8

The proton conductor according to Example 7 was vacuum dried at 120° C. Then, orthophosphoric acid was added in amount of 8 equivalents with respect to La, and was mixed in a mortar for 10 minutes under an Ar atmosphere. Accordingly, a gelled proton conductor according to Example 8 was obtained. In Example 8, in consideration of La having the coordination number of 12, the addition amount of orthophosphoric acid was set to be 8 equivalents with respect to La.

In the proton conductor according to Example 8, in a case where the coordination number of La is 6, two H₂O in the proton conductor according to Example 7 are substituted with H₃PO₄, and four H₂PO₄⁻ and two H₃PO₄ are chemically bonded to La³⁺. In the proton conductor according to Example 8, in a case where the coordination number of La is 12, eight H₂O in the proton conductor according to Example 7 are substituted with H₃PO₄, and four H₂PO₄⁻ and eight H₃PO₄ are chemically bonded to La³⁺.

### Comparative Example

Orthophosphoric acid heated to 150° C. was impregnated with polybenzimidazole (FBI) for 2 hours to obtain a material of a proton conductor. The material of the proton conductor and water as a solvent were mixed in an eggplant flask. Accordingly, a proton conductor in which phosphoric acid was doped to FBI was obtained. The proton conductor according to the comparative example is solid.

Next, results of specifying structures of the proton conductors according to Examples 1 and 2 by electrospray ionization mass spectrometry (ESI-MS) will be described. In mass spectrometry, a quadrupole mass spectrometer was used.

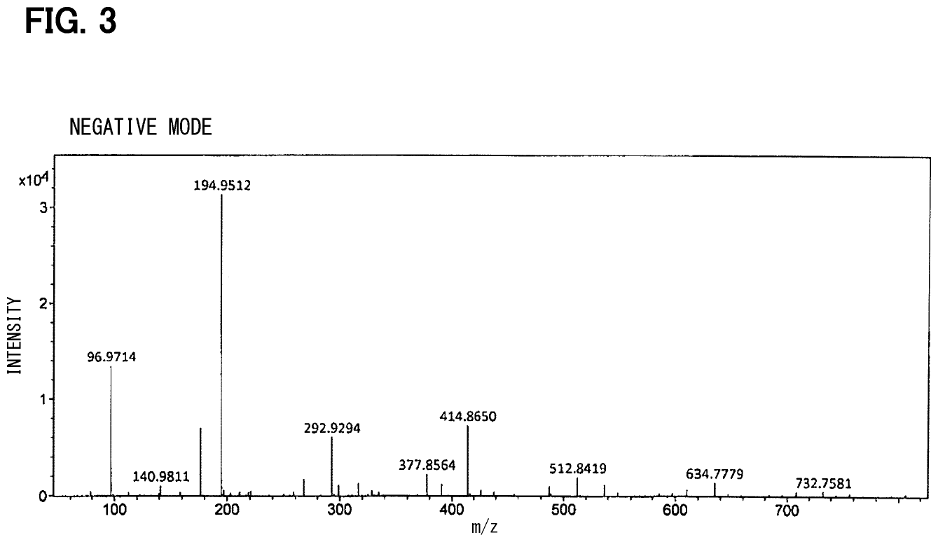

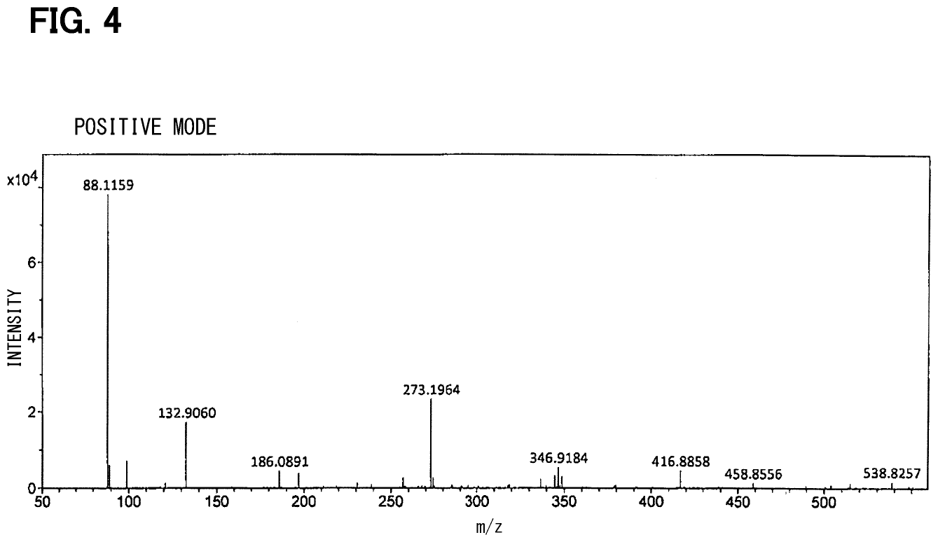

By mass spectrometry of the proton conductor according to Example 1, an anionic mass spectrum shown in FIG. 3 and a cationic mass spectrum shown in FIG. 4 were obtained.

In the anionic mass spectrum shown in FIG. 3, peaks appeared at 414.8650, 292.9294, 194.9512, and 96.9714. Each peak of 292.9294, 194.9512, and 96.9714 is derived from a fragment generated during the measurement.

The peak at 414.8650 is derived from a structure of chemical formula (1) shown below.

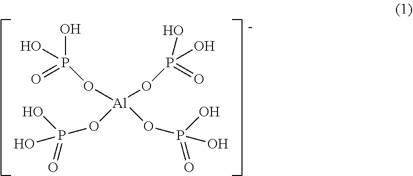

Chemical formula (1) shows the structure of the anionic molecule included in the proton conductor according to Example 1. It can be considered that the structure of chemical formula (1) was obtained by separation of two H₂O from the anionic molecule according to Example 1 during the measurement.

In the cationic mass spectrum shown in FIG. 4, a peak appeared at 88.1159. The peak at 88.1159 is derived from a structure of chemical formula (2) shown below.

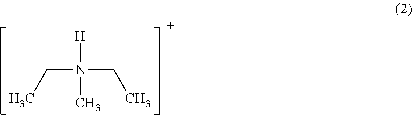

Chemical formula (2) shows the structure of the cationic organic molecule included in the proton conductor according to Example 1.

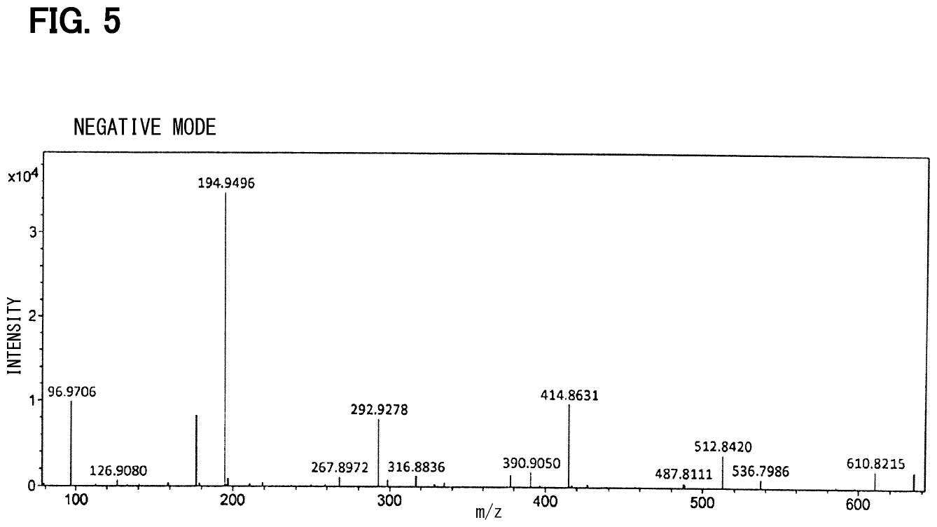

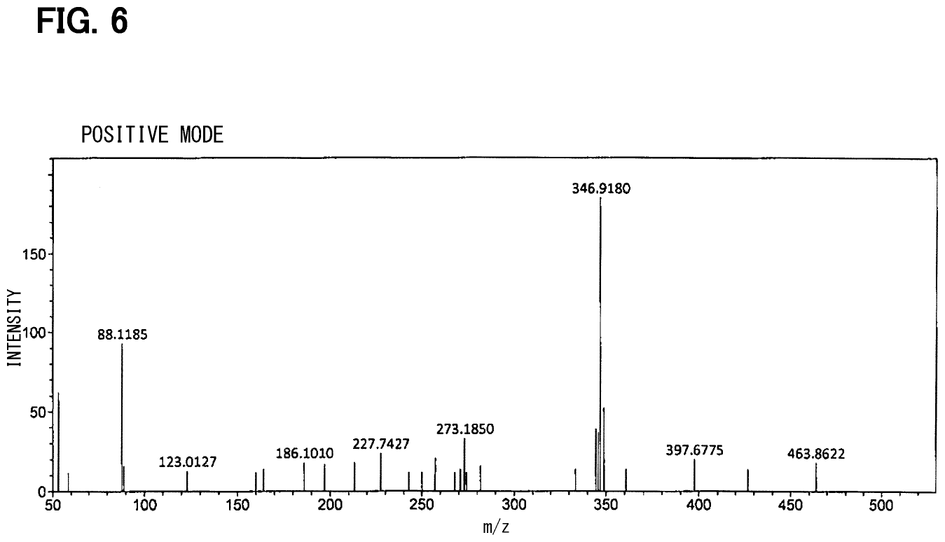

By mass spectrometry of the proton conductor according to Example 2, an anionic mass spectrum shown in FIG. 5 and a cationic mass spectrum shown in FIG. 6 were obtained.

In the anionic mass spectrum shown in FIG. 5, peaks appeared at 610.8215, 512.8420, 414.8631, 292.9278, 194.9496, and 96.9706. Each peak of 292.9278, 194.9498, and 96.9706 peaks is derived from a fragment generated during the measurement.

The peak at 610.8215 is derived from a structure of chemical formula (3) shown below.

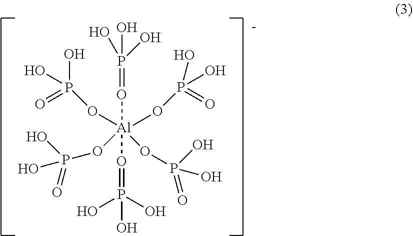

The peak at 512.8420 is derived from a structure of chemical formula (4) shown below.

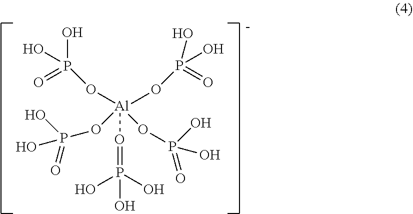

The peak at 414.8631 is derived from the structure of chemical formula (1).

Chemical formulas (1), (3), and (4) indicate the structures of anionic molecules included in the proton conductor according to Example 2. It can be considered that the structure of the chemical formula (4) was obtained by separation of one H₃PO₄ from the anionic molecule according to Example 2 during the measurement. It can be considered that the structure of the chemical formula (1) was obtained by separation of two H₃PO₄ from the anionic molecule according to Example 2 during the measurement.

In the cationic mass spectrum shown in FIG. 6, a peak appeared at 88.1185. The peak at 88.1185 is derived from the structure of chemical formula (2). Chemical formula (2) shows the structure of the cationic organic molecule included in the proton conductor according to Example 2.

Next, results of analyzing the structure of the proton conductors according to Examples 1 and 2 by X-ray total scattering analysis will be described.

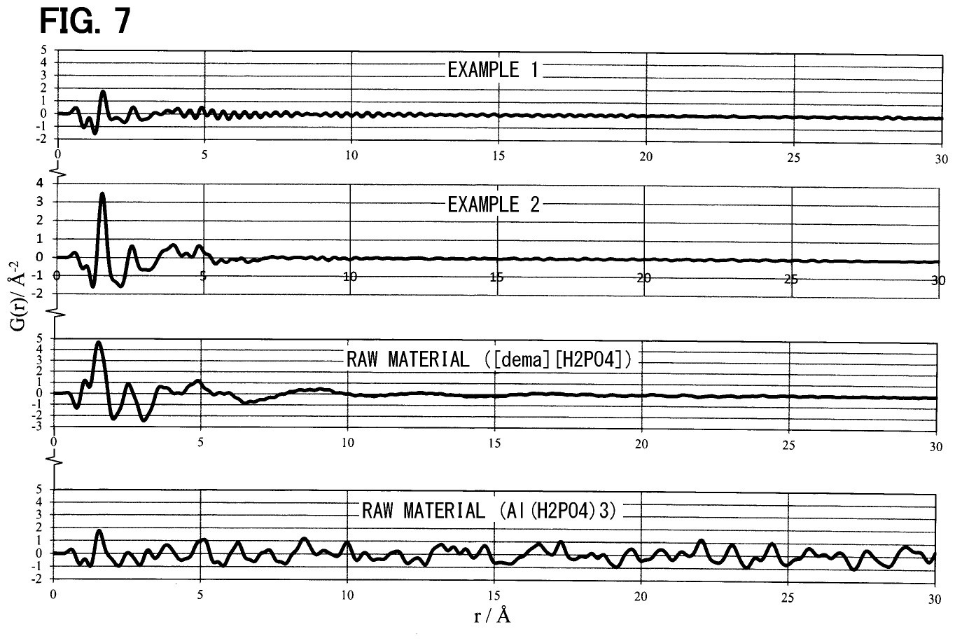

In FIG. 7, spectra of the proton conductor according to Examples 1 and 2, and spectra of diethylmethylammonium dihydrogenphosphate ([dema] [H₂PO₄]) and aluminum dihydrogen phosphate (Al(H₂PO₄)₃), which are the raw materials, are shown. The vertical axis in FIG. 7 is a reduced pair distribution function obtained by Fourier transforming X-ray scattering, and shows the probability that an atom exists at a position of distance r.

As shown in FIG. 7, in the proton conductors according to Examples 1 and 2, peaks different from the raw materials were obtained. Thus, it can be seen that the proton conductors according to Examples 1 and 2 have structures different from the structures of the raw materials.

In addition, in aluminum dihydrogen phosphate (Al(H₂PO₄)₃), which is the raw material, peaks appear continuously, and a periodic structure derived from the crystal structure is observed. In contrast, in the proton conductors according to Examples 1 and 2, no peak appeared in a region larger than 5 to 6 Å, and no periodic structure derived from the crystal structure was observed. Therefore, it can be seen that the proton conductors according to Examples 1 and 2 have amorphous structures.

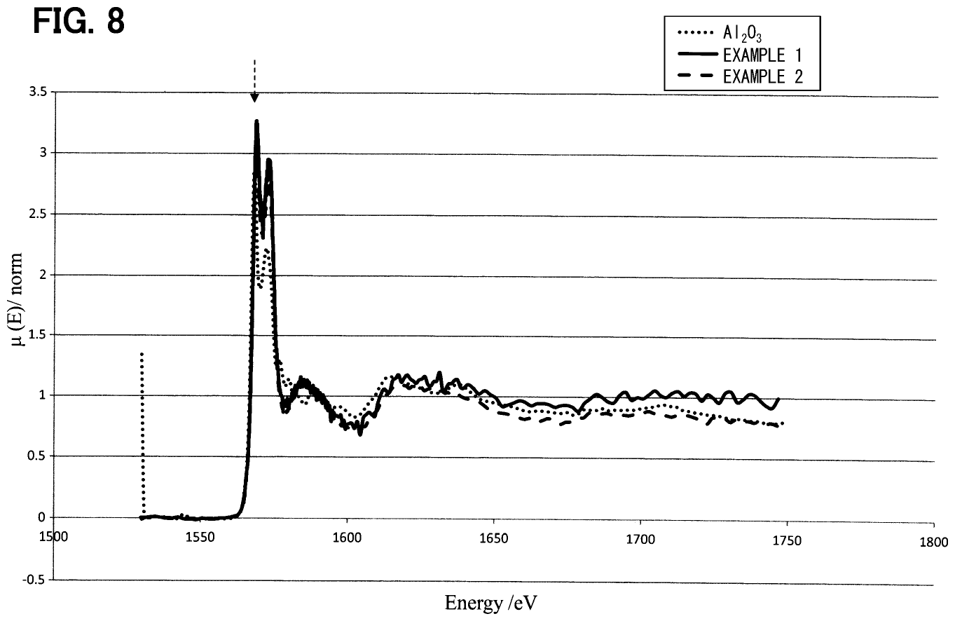

Next, results of analyzing the structures of the proton conductors according to Examples 1 and 2 by X-ray absorption fine structure analysis (XAFS) will be described. FIG. 8 shows spectra of the proton conductors according to Examples 1 and 2 and Al₂O₃ which is a known substance having a coordination number of 6. As shown in FIG. 8, the first rising peak (K absorption edge) of each substance was 1568.077 eV for Al₂O₃, 1568.947 eV for Example 1, and 1568.273 eV for Example 2. That is, the K absorption edges of the proton conductors according to Examples 1 and 2 coincide with the K absorption edge of Al₂O₃. Thus, in the proton conductors according to Examples 1 and 2, it can be seen that the coordination number of Al is 6.

From the structural analysis described above, it can be identified that the proton conductor according to Example 1 has the structure of chemical formula (5) shown below, and the proton conductor according to Example 2 has the structure of chemical formula (6) shown below.

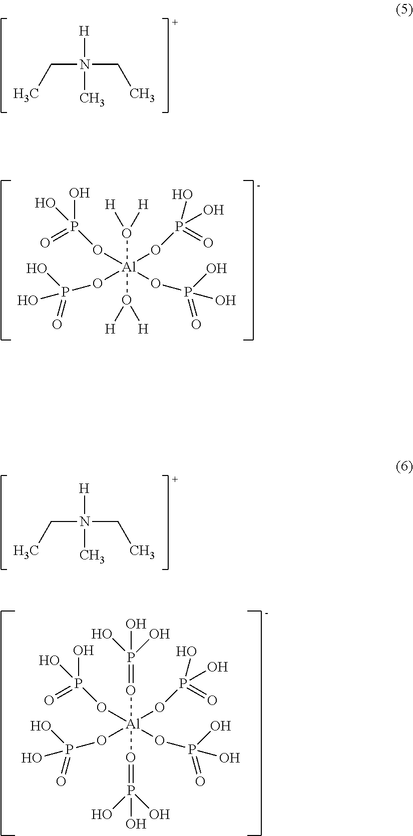

In chemical formula (5), the chemical bond between Al³⁺ and H₂O is weaker than the chemical bond between Al³⁺ having a positive charge and H₂PO₄⁻ having a negative charge. Similarly, in chemical formula (6), the chemical bond between Al³⁺ and H₃PO₄ is weaker than the chemical bond between Al³⁺ and H₂PO₄⁻.

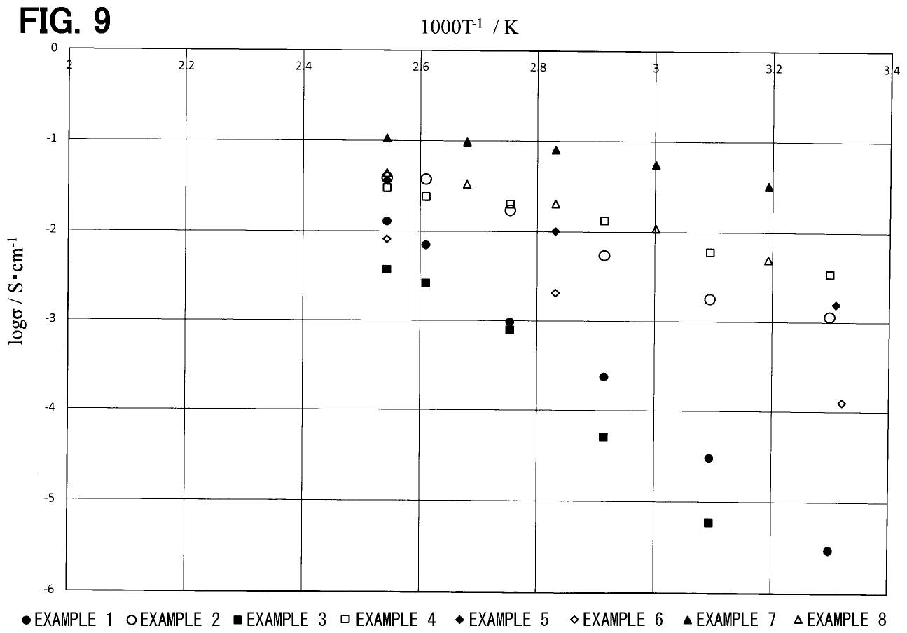

Next, the relationships between the ionic conductivities and the temperatures of the proton conductors according to Examples 1 to 8 will be described. FIG. 9 shows the ionic conductivities of the proton conductors measured at different temperatures. In FIG. 9, the horizontal axis is the temperature, and the temperature increases toward the left side. In FIG. 9, the vicinity of the scale 2.7 on the horizontal axis corresponds to 100° C.

As shown in FIG. 9, the proton conductors according to Examples 1 to 8 have high ion conductivities of about 10⁻² S/cm order or more in the temperature range exceeding 100° C.

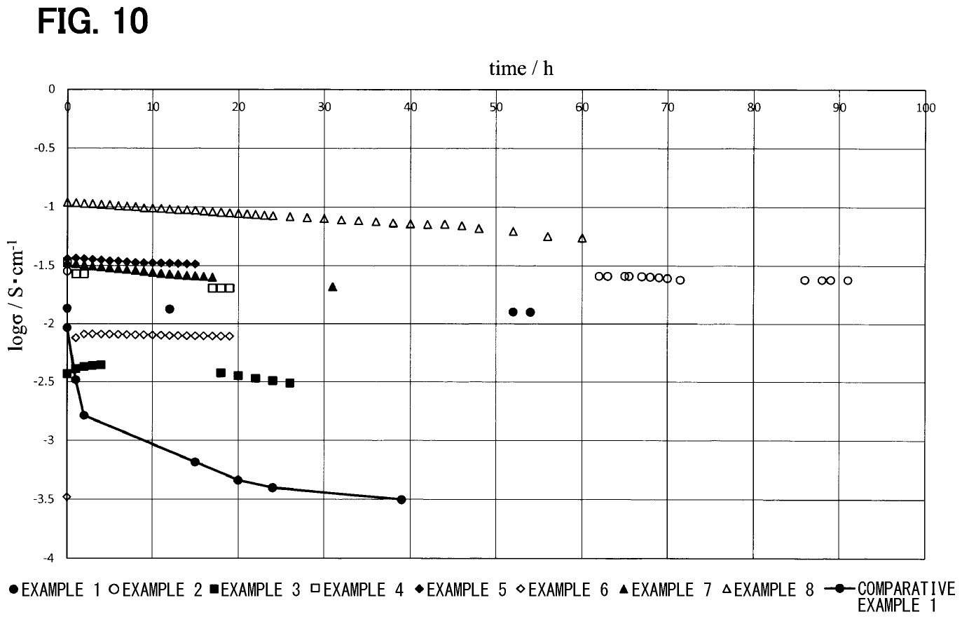

Next, temporal changes in ionic conductivity of the proton conductors according to Examples 1 to 8 and the comparative example will be described. FIG. 10 shows the temporal changes in ionic conductivity when the proton conductors are heated at 120° C. in a nitrogen atmosphere.

As shown in FIG. 10, the ionic conductivity of the proton conductor according to the comparative example is significantly reduced with the lapse of time. This is considered to be caused by the condensation of phosphoric acid with the lapse of time.

On the other hand, in the proton conductors according to Examples 1 to 8, the ionic conductivity does not substantially change with the lapse of time, and a decrease in ionic conductivity can be suppressed over a long period of time. That is, the proton conductors according to Examples 1 to 8 can maintain the molecular structures over a long period of time and have excellent durabilities.

The proton conductor according to the present embodiment described above includes the cationic organic molecule and the anionic metal complex molecule. In the anionic metal complex molecule, the oxoacid ion as the ligand is chemically bonded to the metal ion. The metal ion and the oxoacid ion are strongly bonded by the chemical bond, and the oxoacid ion can be restricted from separating and flowing out from the proton conductor. Accordingly, a stability of the structure of the proton conductor can be improved, and a decrease in proton conductivity can be suppressed.

In the proton conductor according to the present embodiment, the multiple oxoacid ions are chemically bonded to the metal ion. Thus, the multiple proton conduction paths are formed per structure, and the proton conduction performance can be improved.

Moreover, in the proton conductor according to the present embodiment, since the cationic organic molecule and the anionic molecule are weakly bonded by charges with opposite signs, the structure can be the gelled substance. The gelled structure can increase the proton mobility, and can further increase the proton conductivity.

### OTHER EMBODIMENTS

The present disclosure is not limited to the embodiment described above, and various modifications can be made as follows within a range not departing from the spirit of the present disclosure.

For example, in the above embodiment, an example in which the proton conductor of the present disclosure is applied as the electrolyte membrane 130 of the fuel cell 100 has been described, but the proton conductor of the present disclosure is not limited to the above example, and may be used for applications other than fuel cells such as steam electrolysis and hydrogen separation membranes.

What is claimed is:

1. A proton conductor comprising:
an anionic molecule; and
a cationic organic molecule, wherein
the anionic molecule is an anionic metal complex molecule.

2. The proton conductor according to claim 1, wherein
the anionic metal complex molecule includes at least one chemical bond between a metal ion and an oxoacid ion.

3. The proton conductor according to claim 2, wherein
the oxoacid ion includes phosphoric acid.

4. The proton conductor according to claim 2, wherein
the metal ion includes at least one metal selected from the group consisting of Al, Ga, Cs, Ba, K, Ca, Na, Mg, Zr, Ti, La and Pr.

5. The proton conductor according to claim 1, wherein
the cationic organic molecule includes at least one selected from the group consisting of ammonium cation, imidazolium cation, pyridinium cation, pyrrolidinium cation, and phosphonium cation.

6. A fuel cell comprising an electrolyte membrane made of a proton conductor that includes:
an anionic molecule; and
a cationic organic molecules, wherein
the anionic molecule is an anionic metal complex molecule.

7. The fuel cell according to claim 6, wherein
the anionic metal complex molecule includes at least one chemical bond between a metal ion and an oxoacid ion.

8. The fuel cell according to claim 7, wherein
the oxoacid ion includes phosphoric acid.

9. The fuel cell according to claim 7, wherein
the metal ion includes at least one metal selected from the group consisting of Al, Ga, Cs, Ba, K, Ca, Na, Mg, Zr, Ti, La and Pr.

10. The fuel cell according to claim 6, wherein
the cationic organic molecule includes at least one selected from the group consisting of ammonium cation, imidazolium cation, pyridinium cation, pyrrolidinium cation, and phosphonium cation.
